(19) United States
(12) Patent Application Publication
(10) Pub. No.: US 2016/0012197 A1
(43) Pub. Date: Jan. 14, 2016

(54) HEALTH ADVISING SYSTEM

(71) Applicants: Ersno Eromo, Ghent, NY (US); Ronny Kafiluddi, Loudonville, NY (US)

(72) Inventors: Ersno Eromo, Ghent, NY (US); Ronny Kafiluddi, Loudonville, NY (US)

(21) Appl. No.: 14/674,442

(22) Filed: Mar. 31, 2015

Related U.S. Application Data
(60) Provisional application No. 61/973,264, filed on Apr. 1, 2014.

(51) Int. Cl. G06F 19/00

(52) U.S. Cl. CPC G06F 19/3418; G06F 19/345

(57) ABSTRACT

A health advising system uses a spoken language to interact with a patient regarding a health concern and to generate a preliminary diagnosis for a health condition. The health advising system generates a recommendation of a caregiver for the health condition. The health advising system can also assist with scheduling an appointment, advising on transportation options and travel directions, and assist with financial considerations.

### CROSS-REFERENCE TO RELATED APPLICATION

This application claims priority to U.S. Application No. 61/973,264, filed Apr. 1, 2014, titled Health Advising System, the disclosure of which is hereby incorporated by reference in its entirety.

### BACKGROUND

The Centers for Disease Control and Prevention research indicates that at least 500 million people have chronic diseases. About eighty percent of those people live in a third world country where access to health care is often limited.

Of those people that are evaluated by a physician, it is estimated that ten to twenty percent of all illnesses are misdiagnosed. Of the misdiagnosed cases, it is estimated that 28% are fatal.

### SUMMARY

In general terms, this disclosure is directed to a health advising system. In one possible configuration and by non-limiting example, the health advising system provides a personalized patient-centric service that allows a patient to investigate his or her own health concerns and obtain a preliminary diagnosis. When needed, the health advising system guides the patient step-by-step to finding and obtaining the best care available according to his or her unique situation. Various aspects are described in this disclosure, which include, but are not limited to, the following aspects.

One aspect is a health advising system comprising at least one computing device, the computing device storing data instructions, which when executed by the computing device generate: a natural language engine operable to communicate with a patient through audible words; a patient prompting engine operable to prompt a patient to describe a health concern; a diagnostic engine operable to evaluate the description of the health concern provided by the patient and to identify one or more possible diagnoses, wherein one of the diagnoses defines a health condition; and a caregiver identification engine operable to generate a recommendation of a caregiver based at least in part on the identified health condition.

Another aspect is a caregiver ranking engine.

A further aspect is a travel and transportation engine.

Another aspect is a payment and funding engine.

Yet another aspect is an appointment scheduling engine.

A further aspect is a patient monitoring engine.

### BRIEF DESCRIPTION OF THE DRAWINGS

FIG. 1 is a schematic block diagram illustrating an example health advising system.

FIG. 2 is a schematic block diagram of an example health advising server of the health advising system shown in FIG. 1.

FIG. 3 is a functional block diagram of an example of the health advising system of FIG. 1.

FIG. 4 is a schematic block diagram of an example of a natural language engine of the health advising system of FIG. 1.

FIG. 5 is a diagram illustrating a method of prompting a patient for information regarding a health concern.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates to a health advising system. Some embodiments of the health advising system include one or more of the following aspects.

One aspect of the health advising system provides everyone around the world, whether in first-world countries or third-world countries, with access to the same world-class health care.

Another aspect of some embodiments of the health advising system is a preliminary diagnostician that utilizes one or more of: natural language processing, machine learning, artificial intelligence (such as automated reasoning), information retrieval, open domain question answering, and knowledge representation technologies to scour medical information sources and generate a preliminary diagnosis for a patient based on prompting the patient to answer questions about the medical concern. In some embodiments the health advising system includes a natural language engine that poses simple questions to the patient in an audible form using the patient's native language, making it very natural and easy to interact with the health advising system. Simple questions are selected by the health advising system to permit it to quickly navigate through the vast array of possible diagnoses and to identify one or more likely diagnoses.

Some embodiments include a question answering computing system. One example of the question answering computing system is the WATSON question answering computing system available from IBM Corporation of Armonk, N.Y. In some embodiments the question answering computing system includes one or more of: natural language processing (including receiving inputs from the patient via spoken words and generating outputs with spoken words), deep parsing, question analysis, textual resource acquisition, automatic knowledge extraction, search and candidate generation, generating candidate answers using type coercion, textual evidence gathering and analysis, structure data and inference, identifying implicit relationships, fact-based question decomposition, and merging and ranking documents, for example.

A further aspect of some embodiments of the health advising system is a caregiver finder. Once a likely diagnosis has been identified, the health advising system assists the patient in identifying one or more caregivers that are skilled at treating the medical condition. In some embodiments the health advising system interacts with the patient to identify one or more caregivers that would best meet the patient's unique situation. In addition to finding a caregiver qualified to care for the particular medical condition, the health advising system also considers other caregiver selection factors, in some embodiments, to generate one or more caregiver recommendations for the patient. Examples of caregiver selection factors include one or more of: the patient's location, the caregiver's location, the patient's financial resources, the severity of the medical condition, the urgency of the medical condition, the patient's spoken language(s), factors relating to insurance coverage (e.g., in-network, out-of-network), past experiences of others (e.g., rankings; referrals; recommendations; social media; public records; referral or recommendation systems; advertising, connections with friends, relatives, contacts (e.g., from a friends list, social media, contacts on smartphone, contacts in e-mail or social networking system); others experiencing the same or similar medical concerns and/or having the same medical condition), caregiver qualifications, caregiver availability, and other caregiver selection factors.

Another aspect of the health advising system assists the patient with scheduling an appointment with the caregiver. In some embodiments appointments are scheduled directly by the health advising system, and the health advising system interacts with the patient to select an appropriate date and time for the appointment. In some embodiments the health advising system considers the patient's medical condition (including the severity and/or urgency thereof), the caregiver's availability, and the desires of the patient (such as what date and time is most convenient or most desired by the patient). In some embodiments the health advising system automatically provides the caregiver information that is needed by the caregiver which is already known by the health advising system about the patient, and prompts the patient for any additional information that is needed by the caregiver. Examples of information that may be needed by the caregiver includes patient information (e.g., name, date of birth, government identification number, insurance information, medical history, description of chief complaint, description of current symptoms and severities, and the like). Collecting and providing this information to the caregiver prior to the appointment streamlines the process by allowing the physician to be fully prepared for the visit, and reduces or eliminates the time required by the patient to fill out forms or provide additional information after arrival, for example.

Another aspect of the health advising system is a transportation advising system. In some embodiments the health advising system assists the patient in determining a best mode of transportation to the caregiver, and/or provides assistance to the patient in getting to the caregiver at the scheduled date and time. For example, in some embodiments the health advising system includes public and/or private transportation information, such as information about transportation options including transportation by air (e.g., airplane, helicopter), land (e.g., car, taxi, bus, subway, train), or water (e.g., boat, ship). In some embodiments, transportation schedules and availability information is used to interact with the patient and generate a recommended transportation plan. In some embodiments the health advising system includes a locating system, such as a GPS location identification system, to determine a current location and provide instructions to the patient along the way. For example, the health advising system provides one or more of a map, turn-by-turn driving directions, transportation schedules and route information, transfer instructions, and the like, in some embodiments. In some embodiments the health advising system includes, interacts with, or refers the patient to a travel partner, such as a travel agent, or travel network (e.g., the UBER travel network). Some embodiments utilize a geographic mapping application to generate map displays associated with the transportation.

Another aspect of the health advising system is a financial advising system. The financial advising system assists the patient in understanding and/or developing a plan for payment of the costs associated with medical care for the medical condition. In some embodiments the financial advising system generates cost estimates for the medical care. In some embodiments the financial advising system receives or looks up information associated with the patient's insurance coverage to generate an estimate of the portion of the cost that will be the patient's responsibility after contribution or discounts applied due to the insurance coverage.

In some embodiments the financial advising system includes crowd funding engine. If the estimated costs associated with the medical care exceed the patient's available financial resources, the crowd funding engine can be used by the patient to request assistance from others to fund the medical expenses. In some embodiments, the crowd funding engine interacts with the patient, and in some cases with the caregiver, to generate a funding request. The funding request is published with information about the patient, the patient's condition, the estimated cost associated with the medical care, and a funding deadline. The crowd funding engine receives donations from people that want to help the patient obtain the medical care. In some embodiments the donations are stored in an escrow account. In some embodiments the donations are held and allowed to accumulate in the escrow account until the estimated cost associated with the medical care has been covered by the donations, or until the funding deadline has expired. If suitable funds are received, the funds are then released to the caregiver to provide the medical care. If suitable funds are not received by the deadline, in some embodiments the funds are returned, while in other embodiments the donations are reassigned to another patient's funding request. In some embodiments the donor is prompted to select whether unused funds should be returned or whether they should be reassigned to another patient's funding request. In some embodiments, unused funds can be reassigned to another patient's funding request selected by the donor.

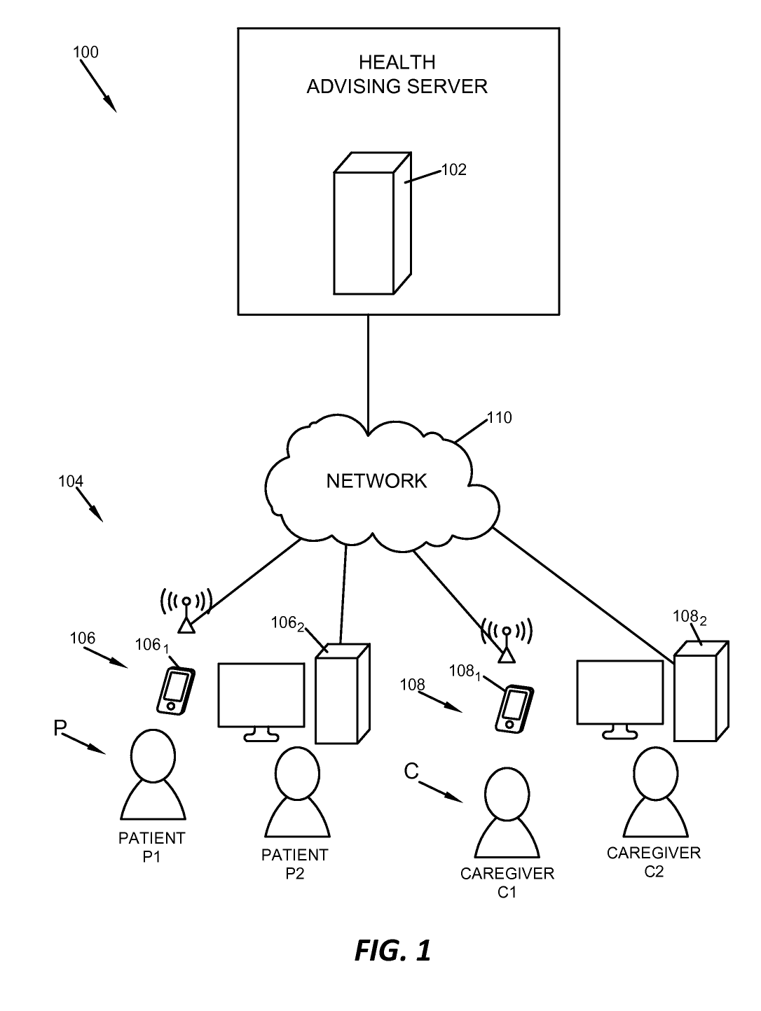

FIG. 1 is a schematic block diagram illustrating an example health advising system 100. In this example, the health advising system includes a health advising server 102 and user computing devices 104. User computing devices 104 include patient computing devices 106 and caregiver computing devices. Also shown are patients P and caregivers C, and the data communication network 110.

The health advising server 102 includes one or more computing devices that operate to perform one or more of the functions of the health advising system 100 discussed herein. Although the health advising server 102 is described herein for simplicity as a single “server 102,” the server can include any number of server computing devices, which can be located at a single location or distributed across multiple different locations. Accordingly, some embodiments of the health advising server 102 may perform only one or more of the functions described herein, while another health advising server 102 may perform one or more other functions, etc. Further, the health advising server 102 can include or interact with other third-party systems. Examples of such third-party systems include a source of medical records (e.g., an electronic medical records system, a health information exchange system, and the like), a source of medical knowledge (e.g., a medical terminology data source, an intelligent prompting data source, medical journals, academic articles, and other medical research sources), contact information (such as a contact list data source, a friend or contact list from a social networking system), a caregiver information sources (e.g., a caregiver ranking, review, or feedback system; a caregiver qualification system), a travel or transportation system, or other possible third-party information sources.

The user computing device 104 is a computing device operated by a user. In some embodiments the user computing device 104 includes a patient computing device 106 and a caregiver computing device 108. The patient computing device 106 is a computing device operated by the patient P. The caregiver computing device 108 is a computing device operated by the caregiver C. An example of the user computing device (including the patient computing device 106 or the caregiver computing device 108) is a smartphone, or other mobile computing device. Another example is a wearable computing device, such as the Google Glass wearable computing device, and a watch-style computing device. Other examples of the user computing device 104 include a desktop computer, laptop computer, tablet computer, and a cellular or other mobile telephone.

In some embodiments the user computing device 104 operates in cooperation with the health advising server 102 to put world-class, convenient health care at the patient or caregiver's fingertips. In some embodiments the user computing device 104 is a web-enabled device that communicates with the health advising server 102 through a web browser software application, such as in a software-as-a-service computing model. In other embodiments the user computing device 104 includes a local software application running on the user computing device 104, which can communicate with the health advising server 102. Other embodiments utilize other software and data communication models or combinations of multiple different models.

In some embodiments the health advising system 100 includes one or more patient health data sources. A patient health data source is any device capable of collecting data relating to the health of the patient. An example of a patient health data source is a wearable device, such as a glucose sensor, a heart rate monitor, a mobile ECG device, an activity monitor. Another example of a patient health data source is a bedside monitor. Another example of a patient health data source is a weight scale. Another example of a patient health data source is a medical instrument. These and other patient health data sources are included in some embodiments to provide data associated with the health of the patient. In some embodiments the data from a patient health data source is provided to or accessible by the health advising system 100. In some embodiments the data is communicated to the patient computing device 106 or the caregiver computing device 108. In some embodiments the data is sent from the user computing device 104 to the health advising system 100.

The patient P is a human that has a medical concern or a medical condition. In some embodiments the patient is assisted by another person, such as a parent or guardian, a family member, an aide or assistance, or a caregiver.

The caregiver C is a person that is trained to provide care to the patient P. The caregiver can include a physician, a nurse, a therapist, a laboratory technician, or any other person trained to provide care medical conditions. Caregivers are often part of a larger health care facility, such as a clinic, hospital, emergency room, urgent care center, or other care facility.

The user computing devices 104 communicate with the health advising server 102 across the data communication network 110. The data communication network 110 is any one or more data communication networks capable of communicating data between computing devices, such as the Internet. The data communication network 110 can include wireless or wired communication (including electrical and fiber optic communication, for example). Data communication can include wireless data communication through a cellular network, a wireless access point, and the like. Data communication can also include a local area network in some embodiments.

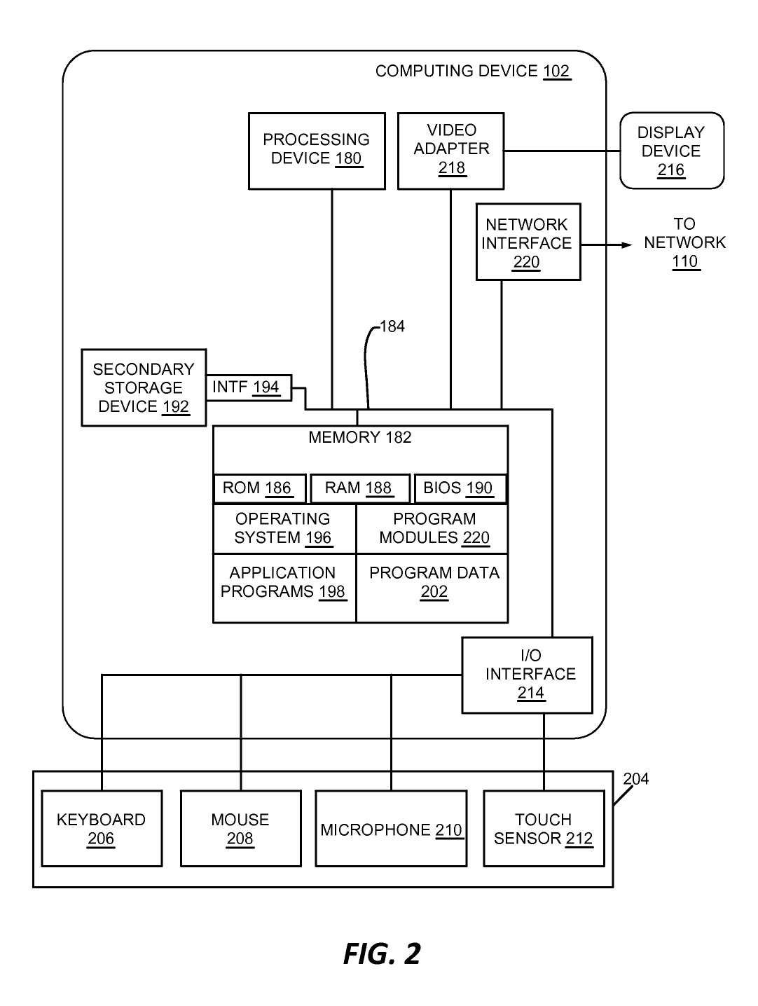

FIG. 2 illustrates an exemplary architecture of a computing device that can be used to implement aspects of the present disclosure, including any of the health advising server computing devices 102 or the user computing devices 104 (including the patient 106 and the caregiver computing devices 108). The computing device illustrated in FIG. 2 can be used to execute the operating system, application programs, and software modules (including the software engines) described herein. By way of example, the computing device shown in FIG. 2 is described as the health advising server computing device 102, but also illustrates a configuration suitable for any of the user computing devices 104 as well. To avoid undue repetition, this description of the computing device will not be separately repeated herein for each of the other computing devices 104, or possible third-party computing devices discussed herein, but such devices can also be configured as illustrated and described with reference to FIG. 2, or in other configurations according to the particular type of computing device in which it is implemented.

The computing device 102 includes, in some embodiments, at least one processing device 180, such as a central processing unit (CPU). A variety of processing devices are available from a variety of manufacturers, for example, Intel or Advanced Micro Devices. In this example, the computing device 102 also includes a system memory 182, and a system bus 184 that couples various system components including the system memory 182 to the processing device 180. The system bus 184 is one of any number of types of bus structures including a memory bus, or memory controller; a peripheral bus; and a local bus using any of a variety of bus architectures.

Examples of computing devices suitable for the computing device 102 include a desktop computer, a laptop computer, a tablet computer, a mobile computing device (such as a smart phone, an iPod® or iPad® mobile digital device, or other mobile devices), or other devices configured to process digital instructions.

The system memory 182 includes read only memory 186 and random access memory 188. A basic input/output system 190 containing the basic routines that act to transfer information within computing device 102, such as during start up, is typically stored in the read only memory 186.

The computing device 102 also includes a secondary storage device 192 in some embodiments, such as a hard disk drive, for storing digital data. The secondary storage device 192 is connected to the system bus 184 by a secondary storage interface 194. The secondary storage devices 192 and their associated computer readable media provide nonvolatile storage of computer readable instructions (including application programs and program modules), data structures, and other data for the computing device 102.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 192 or memory 182, including an operating system 196, one or more application programs 198, other program modules 200 (such as the software engines described herein), and program data 202. The computing device 102 can utilize any suitable operating system, such as Microsoft Windows™, Google Chrome™, Apple OS, and any other operating system suitable for a computing device.

In some embodiments, a user provides inputs to the computing device 102 through one or more input devices 204. Examples of input devices 204 include a keyboard 206, mouse 208, microphone 210, and touch sensor 212 (such as a touchpad or touch sensitive display). Other embodiments include other input devices 204. The input devices are often connected to the processing device 180 through an input/output interface 214 that is coupled to the system bus 184. These input devices 204 can be connected by any number of input/output interfaces, such as a parallel port, serial port, game port, or a universal serial bus. Wireless communication between input devices and the interface 214 is possible as well, and includes infrared, BLUETOOTH® wireless technology, 802.11a/b/g/n, cellular, or other radio frequency communication systems in some possible embodiments.

In this example embodiment, a display device 216, such as a monitor, liquid crystal display device, projector, or touch sensitive display device, is also connected to the system bus 184 via an interface, such as a video adapter 218. In addition to the display device 216, the computing device 102 can include various other peripheral devices (not shown), such as speakers or a printer.

When used in a local area networking environment or a wide area networking environment (such as the Internet), the computing device 102 is typically connected to the network 112 through a network interface 220, such as an Ethernet interface. Other possible embodiments use other communication devices. For example, some embodiments of the computing device 102 include a modem for communicating across the network.

The computing device 102 typically includes at least some form of computer readable media. Computer readable media includes any available media that can be accessed by the computing device 102. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 102. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 2 is also an example of programmable electronics, which may include one or more such computing devices, and when multiple computing devices are included, such computing devices can be coupled together with a suitable data communication network so as to collectively perform the various functions, methods, or operations disclosed herein.

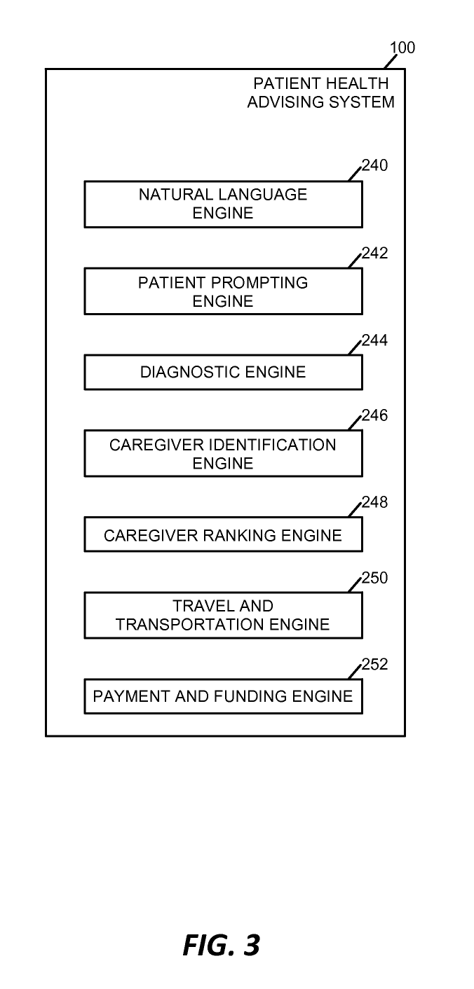

FIG. 3 is a functional block diagram illustrating an example of the health advising system 100. In this example, aspects of the patient health advising system 100 can be implemented on any one or more of the health advising server 102, patient computing device 106, or caregiver computing device 108, for example.

In this example, the patient health advising system 100 includes a natural language engine 240, patient prompting engine 242, diagnostic engine 244, caregiver identification engine 246, caregiver ranking engine 248, travel and transportation engine 250, and a payment and funding engine 252.

The natural language engine 240 operates to enable the patient health advising system 100 to interact with the patient P and/or the caregiver C through audible words. In some embodiments the natural language engine 240 generates outputs, such as in the form of questions or information and instructions, and receives inputs spoken by the user. In some embodiments the natural language engine 240 is fluent in many different languages. In some embodiments the natural language engine 240 automatically determines a user's language by listening to the user speaking, comparing the detected words with the known languages to identify the spoken language, and then utilizes that language for the duration of the interaction with that user. The ability to automatically detect and communicate with the user in the user's native language makes the natural language engine 240 easy, intuitive, and comfortable for a user to use, even if the user is not technologically savvy.

The patient prompting engine 242 operates to interact with the patient or caregiver, such as using the natural language engine 240, to query the patient or caregiver regarding the patient's medical concern. As one example, the patient prompting engine 242 first asks the patient to briefly describe the medical concern, and then generates subsequent questions regarding the medical concern. For example, the patient prompting engine 242 generates questions regarding the patient's symptoms that the patient is experiencing due to the health concern. In some embodiments the patient prompting engine utilizes a scoring algorithm to select each question, where the selected question is chosen as the question having the highest score, indicating that the question is the most likely question to be helpful in identifying the medical concern.

The diagnostic engine 244 operates to diagnose a medical condition. In some embodiments the diagnostic engine 244 identifies a single most-likely diagnosis, while in other embodiments the diagnostic engine 244 generates a set of possible diagnoses. In some embodiments the diagnostic engine 244 generates a probability score for each diagnosis, which is presented to the patient or caregiver along with the diagnosis. In some embodiments the diagnostic engine also includes citations to evidence or medical knowledge used to generate the diagnosis for review by the patient or caregiver. The diagnostic engine 244 generates a diagnosis using the information collected from the patient prompting engine 242, and can also utilize other information, such as historical medical data for the patient (including health history data), and data from one or more patient health data sources, as discussed herein. In some embodiments the diagnoses generated by the diagnostic engine 244 are a preliminary diagnosis that is subsequently reviewed and verified by a caregiver, such as a physician to arrive at a formal diagnosis. The preliminary diagnosis assists both the patient and the caregiver in timely and accurate diagnosis, and helps to direct patients to proper care and treatment when needed, but may also avoid unnecessary care and treatment when it is not needed, improving efficiency and reducing unnecessary costs in the care of the patients.

The caregiver identification engine 246 operates to assist the patient in finding a caregiver skilled at treating the diagnosed medical condition. The engine 246 can also assist a caregiver that is not specialized in treating a particular medical condition in identifying a caregiver that is specialized in treating a condition. Once the medical condition has been diagnosed, the caregiver identification engine 246 operates to locate one or more caregivers that can assist the patient P with the medical condition. In some embodiments the caregiver identification engine 246 consults one or more data sources to determine what caregivers are capable of or willing to see patients having the particular medical condition. A variety of data sources can be consulted as discussed herein. In some embodiments the caregiver identification engine 246 displays a photograph representing the care facility and/or the caregiver. In some embodiments the current wait time is displayed to help the patient determine how long he or she will likely have to wait to see a caregiver at the present time.

Some embodiments further include a caregiver ranking engine 248. The caregiver ranking engine 248 takes the caregiver identification a step further by evaluating a quality or skill level of the caregivers identified by the caregiver identification engine 246. A variety of data sources can be consulted by the caregiver ranking engine 248, as discussed herein. In some embodiments the caregiver identification engine 246 and the caregiver ranking engine 248 operate to generate one or more caregiver recommendations for the patient.

Some embodiments further include an appointment scheduling engine that operates to assist the patient in scheduling an appointment with a caregiver. Appointment scheduling is discussed in further detail herein.

The travel and transportation engine 250 is an example of the transportation advising system, which assists the patient in determining a best mode of transportation to the caregiver, and/or provides assistance to the patient in getting to the caregiver at the scheduled date and time.

The payment and funding engine 252 is an example of a financial advising system, which operates to assist the patient in determining the potential costs associated with obtaining medical care for the medical condition. In some embodiments, if the cost of the medical care is too large for the patient, the payment and funding engine 252 includes a crowd funding engine, through which the patient can request and receive financial assistance from others to fund the medical care.

Some embodiments further include a patient monitoring engine. The patient monitoring engine operates to monitor and manage patient health concerns over time. In some embodiments, the patient monitoring engine reviews health history data for the patient, including new health history information (including for example routine labs and vital signs data) as it is obtained. If any of the health history data shows a cause for concern, the patient monitoring engine can generate an alert to the patient or a caregiver regarding the concern. In some embodiments the patient monitoring engine can also interact with the patient, such as using the patient prompting engine 242 and the natural language engine 240, to gather additional information and further evaluate the concern. In some embodiments the patient monitoring engine also operates to reevaluate the patient's health history data based on new medical knowledge that is obtained by the health advising system 100. In some embodiments the patient monitoring engine aides the patient in managing a medical condition, such as by providing reminders of actions that should be taken. Examples of such actions include taking medication and scheduling and attending routine physicals or checkups. The patient monitoring engine may also provide additional notifications in some embodiments.

All patient data obtained and stored by the health advising system 100 is carefully protected and is made available only through well-defined and clear patient privacy and terms of use policies and after obtaining consent to the use of such information from the patient. Even then, such information is carefully protected through the use of proper security measures including at least access protection, such as through usernames and passwords, or stronger access protection techniques such as biometric (e.g., iris, fingerprint, etc.) identification or authorization. In some embodiments the health advising system 100 operates to prevent the copying of patient data without authorization from the user, such as a biometric authorization. In some embodiments a caregiver must be granted access to the personal information by the patient before access is granted to a caregiver. Additionally, in some embodiments patient data is stored only for the limited time that it is being used to evaluate a medical concern of the patient, and then is promptly deleted from the health advising system to further protect patient privacy and confidentiality. In the event that the patient has a subsequent medical concern, the health advising system 100 can quickly relearn the information needed to address the current medical concern. In some embodiments information learned by the health advising system 100 is stored only in an anonymous fashion. In this way, the health advising system 100 can learn from interactions with other users, and can store that knowledge absent any information that identifies the patient whose health concern provided the health advising system 100 with that knowledge. In some embodiments the patient is prompted at the end of an interaction with the health advising system 100 to indicate the extent to which the health advising system 100 can remember and/or utilize the information relating to the patient. In some embodiments a patient's health history is stored on the patient's computing device, preferably in an encrypted and secure form, rather than on any other computing device to limit access to that information.

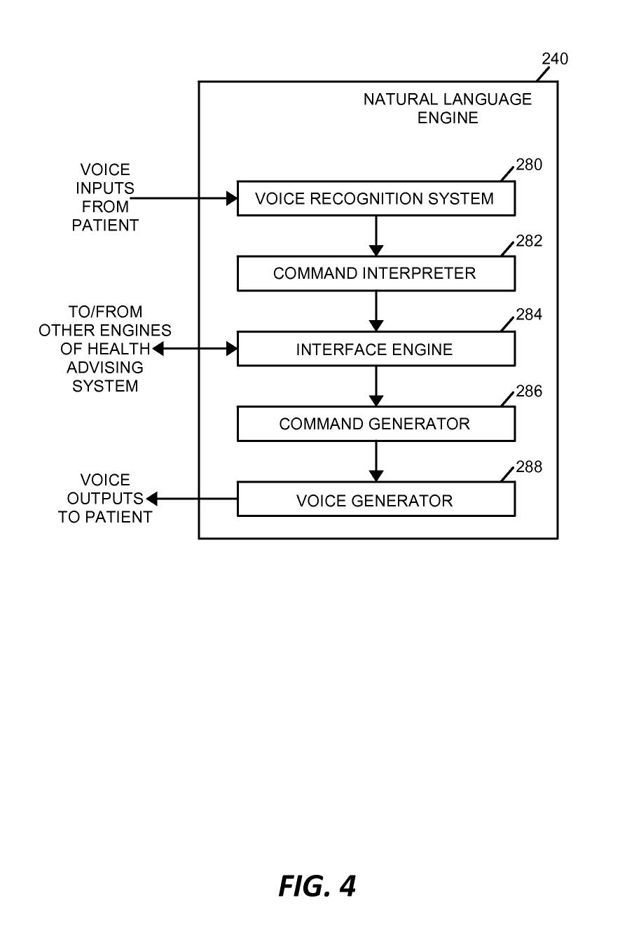

FIG. 4 is a schematic block diagram of an example of the natural language engine 240. In this example, the natural language engine includes a voice recognition system 280, command interpreter 282, interface engine 284, command generator 286, and voice generator 288.

Voice inputs from the patient, or other user, are received at the voice recognition system 280, which processes the sounds and translates the sounds into words. In some embodiments the voice recognition system 280 detects and determines a language that is being spoken, and then uses that language to determine the words.

In some embodiments the words detected by the voice recognition system are processed through a command interpreter, which evaluates the words to determine an appropriate action in response. In some embodiments the command interpreter 282 functions as a translator, to translate between the spoken language of the person and the data understood and usable by the computing device.

The data is then sent from the natural language engine to the appropriate engine of the health advising system 100 for further processing. For example, if a voice input is an answer to a question about a symptom associated with a health concern, data containing the answer to the question is passed to the patient prompting engine 242 or the diagnostic engine 244 for further processing.

Data can also be received from other engines of the health advising system 100 including instructions to communicate certain information to the user. In this example, the data is received by the interface engine 284. The interface engine 284 passes the data to the command generator 286, which translates the data into words in the of the user's language.

The voice generator 288 receives the words from the command generator 286 and causes the generation of audible sounds that are presented to the user through the user computing device 104.

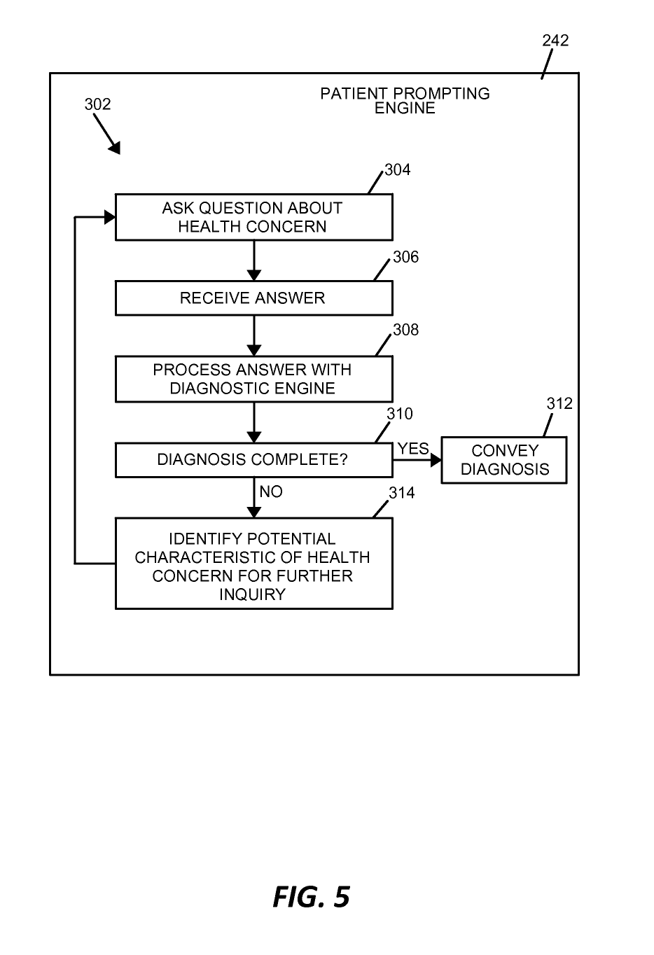

FIG. 5 illustrates an example of the patient prompting engine 242. In this example, the patient prompting engine 242 performs a method 302 of prompting a patient for information regarding a health concern. The method 302 includes operations 304, 306, 308, 310, 312, and 314.

In operation 304 a question is asked to the patient about a health concern. An example of such a question is: “what is the problem you are experiencing?”, or “what part of the body are you concerned about?”

The operation 306 is performed to receive the answer, which is then processed in operation 308 by the diagnostic engine 244, for example.

At operation 310 a determination is made whether the diagnosis is complete. If so, the diagnosis is conveyed in operation 312.

If the diagnosis is not complete, the operation 314 is performed to identify a potential characteristic of the health concern for further inquiry. In some embodiments the operation 314 utilizes the diagnostic engine 244 to identify the characteristic having a greatest likelihood of providing useful information to lead to the proper diagnosis of the health concern. The process is then repeated until the proper diagnosis is identified, or the system concludes that additional information is needed, such as through laboratory testing or consultation with a caregiver. Additionally, the system may also determine that it is likely that there is no health condition raised by the symptoms and that no further evaluation is required.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A health advising system comprising at least one computing device, the computing device storing data instructions, which when executed by the computing device generate:
a natural language engine operable to communicate with a patient through audible words;
a patient prompting engine operable to prompt a patient to describe a health concern;
a diagnostic engine operable to evaluate the description of the health concern provided by the patient and to identify one or more possible diagnoses, wherein one of the diagnoses defines a health condition; and
a caregiver identification engine operable to generate a recommendation of a caregiver based at least in part on the identified health condition.

2. The health advising system of claim 1, further comprising a caregiver ranking engine.

3. The health advising system of claim 1, further comprising a travel and transportation engine.

4. The health advising system of claim 1, further comprising a payment and funding engine.

5. The health advising system of claim 1, further comprising an appointment scheduling engine.

6. The health advising system of claim 1, further comprising a patient monitoring engine.
